(19) United States
(12) Patent Application Publication
(10) Pub. No.: US 2006/0129861 A1
(43) Pub. Date: Jun. 15, 2006

(54) Portable electronic device having high and low power processors operable in a low power mode

(76) Inventors: Martin J. Kee, Sammamish, WA (US); Chao-Chi Chen, Sammamish, WA (US); Rod G. Fleck, Bellevue, WA (US); Craig W. O'Connell, Snohomish, WA (US); Stephen L. Perrin, Lake Forest Park, WA (US); Michael S. Clarke, Mercer Island, WA (US)

Correspondence Address: Edward W. Bulchis, Esq.;DORSEY & WHITNEY LLP, Suite 3400, 1420 Fifth Avenue, Seattle, WA, 98101, US

(21) Appl. No.: 11/351,705

(22) Filed: Feb. 9, 2006

Related U.S. Application Data
(62) Division of application No. 10/871,871, filed on Jun. 17, 2004.
(60) Provisional application No. 60/504,165, filed on Sep. 18, 2003.

(51) Int. Cl. G06F 1/26

(52) U.S. Cl. 713/323

(57) ABSTRACT

A computer system has a main display attached to a computer chassis. The computer chassis includes a high power, high performance main processor running applications on a first operating system platform. The auxiliary display module has a low power, low performance auxiliary processor, a small touch-screen display and a keypad. The main processor interfaces with a keyboard on the upper surface of the chassis and a main display. In a high power mode, there is no display and keypad input in the auxiliary display module. In a power sleep mode, power is removed from the first processor, the main display and many of the components in the computer chassis. However, key functions, such as email, a contact list, and an appointment calendar can be accessed using the auxiliary display module. In a low power mode, the main display shuts off and many of the components in the computer chassis are powered down. However, key functions, such as email, a contact list, an appointment calendar, and a media player, can be accessed using the auxiliary display module.

### CROSS-REFERENCE TO RELATED APPLICATIONS

The present application claims the benefit of the filing date of U.S. Provisional Application No. 60/504,165 entitled SOFTWARE AND HARDWARE FEATURES FOR MINI-PC, filed Sep. 18, 2003, which is incorporated herein by reference.

### FIELD

This relates generally to processor-based systems, and more particularly, to a dual processor computer system operable in a reduced power consumption mode having limited performance.

### BACKGROUND

Personal computers have become indispensable tools for business and personal use. In addition to a wide variety of stand-alone applications that may be run on a personal computer, personal computers also serve as communications terminals for access to the Internet. Portable personal computers, generally known as “laptop” or “notebook” computers, have become increasingly popular because their portability allows access to the wide variety of computer applications when traveling, such as on airplanes. However, the usefulness of such portable computers are frequently limited by the limited useful life of batteries powering the computers before the batteries need to be recharged. Furthermore, although continued progress has been made in reducing the weight and bulk of portable personal computers, they are still fairly difficult to carry in many instances.

Another limitation of conventional personal computers is the inability to use them to quickly review information, such as to look up a phone number or an address. Before the computer can be used to access the information, the computer must be turned on and it then must “boot up” by running an initialization sequence and loading an operating system. This process can take a considerable period of time. Furthermore, it is generally necessary to open the portable computer to turn it on and access the information. It can be difficult to perform this function under certain circumstances, such as when driving a car or sitting in the small confines of an aircraft seat.

Various devices have been developed to address these and other limitations of conventional portable personal computers, such as laptop and notebook computers. The most prevalent of these devices is the personal digital assistant, or “PDA,” which provides some of the functionality of a portable personal computer without the size and weight of such computers. This limited functionality generally includes an appointment calendar, an address or contact list, a task list and email capability when coupled to a suitable communication link, which may be wireless. In some cases, a cellular telephone is built into the PDA, and various applications having limited functionality, such as spreadsheets and word processors, are also available. PDAs offer a convenient means of using the limited functionality that they offer because it is not necessary to open a cover to view their display screens. Furthermore, there is minimal delay in accessing PDAs because their operating system remains stored in random access memory when the PDA is turned off so it may be executed by an internal processor as soon as power is applied to the processor. It is therefore not necessary to wait for a boot sequence to execute and an operating system to be loaded. When the PDA is turned off, power continues to be applied only to essential circuitry like a volatile random access memory, thus preserving the useful life of an internal battery before recharge is needed.

Another approach has been to include auxiliary components in notebook computers either to make them more convenient to use when a display lid of the computer is closed or to consume less power when a limited function, such as playing music, is operational. For example, U.S. Pat. No. 5,768,164 discloses a notebook computer having a small display on an outer surface of the display lid of the computer. A subset of the pixels in a larger main display on the inner surface of the lid is mapped to the small display, which can be viewed when the display lid of the computer is closed. Although the disclosed notebook computer does allow some information to be viewed when the display lid is closed, it provides the complete functionality of the computer at this time, thus making it impractical for long-term use.

Although PDAs have been very successful in making limited computer functions conveniently available to users, they are not without their limitations. In particular, the limited functionality of PDAs coupled with their small display and inconvenient data entry mechanism, make it difficult to use them for many applications, such as word processing and drafting lengthy emails. As a result, travelers using PDA's often bring portable computers with them, and, in many cases, also carry a cellular telephone and sometimes an MP3 music player. All of this functionality could be provided by the personal computer alone, but the limited battery life and inconvenience of use described above make such use impractical.

There is therefore a need for a computer system that provides the ease of use and long battery life of a PDA with the functionality of a notebook computer thus making it unnecessary to own or travel with one or more electronic devices in addition to a notebook computer.

### SUMMARY

One preferred aspect provides a computer system having a first processor supporting the operation of a main display and keyboard, and a second processor supporting the operation of an auxiliary user interface, such as a keypad and either an auxiliary display or a portion of the main display. The first processor is a high power processor that has relatively high processing capabilities but consumes a great deal of power, and the components with which it interfaces also consume a great deal of power. This high power processor provides the substantial functionality of the computer system. The second processor is a low power processor that has relatively low processing capabilities but consumes relatively little power, and it interfaces with components that also consume relatively little power. This low power processor provides limited functionality similar to that of a PDA when the computer system is turned off or is in a low power mode.

### BRIEF DESCRIPTION OF THE DRAWINGS

FIG. 1 is a front isometric view of a computer system according to one embodiment showing a display lid in its open position.

FIG. 2 is a top plan view of the surface of the display lid of the computer system of FIG. 1.

FIG. 3 is a rear isometric view of a rear panel of the computer system of FIG. 1

FIG. 4 is a hardware system block diagram of one embodiment of the computer system of FIG. 1.

FIG. 5 is a software system block diagram of one embodiment of the computer system of FIG. 1.

FIG. 6 is a software system block diagram of another embodiment of the computer system of FIG. 1.

### DETAILED DESCRIPTION

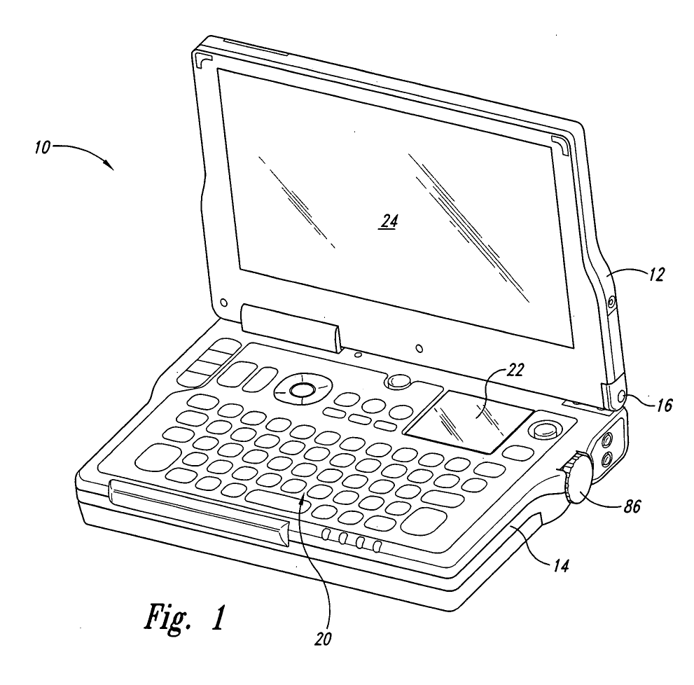

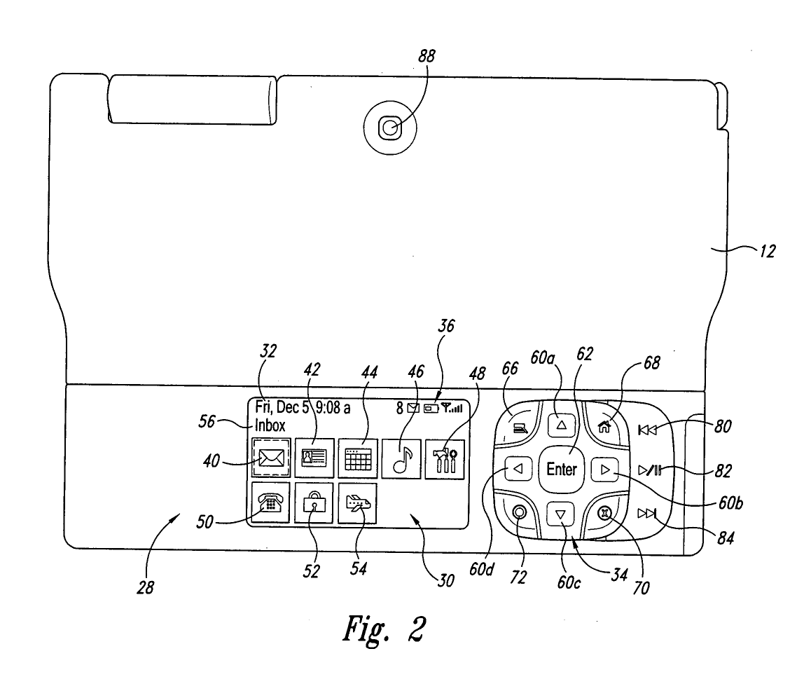

A computer system 10 according to one embodiment of the present invention is shown in FIG. 1. The computer system 10 is an example of a computer system with a “clam shell” structure formed by a lid 12 pivotally mounted to a chassis 14 at one edge 16. A keyboard 20 covers substantially the entire inner surface of the chassis 14 except for an area occupied by a touchpad 22 pointing device. A main display 24 covers substantially the entire inner surface of the lid 12. The computer system 10 is turned on by pressing an appropriate key on the keyboard 20, and the keyboard 20 is used to enter alphanumeric data. Although the computer system 10 may be substantially the size of a conventional notebook computer, i.e., on the order of 250 mm by 300 mm in plan form, it is preferable only slightly larger than a conventional PDA, i.e., on the order of 100 mm by 150 mm with a thickness of about 25 mm. However, it will be understood that the computer system may have a physical structure and user interface device that are different from those shown in FIG. 1. With reference to FIG. 2, the outer surface of the lid 12 includes a Low Power Interactive Display Module (“LID module”) 28 that includes an auxiliary touch-screen display 30 and a membrane keypad 34. Shown on the display 30 are the current date and time 32, status icons 36, including status indicators showing the number of new email messages, the charge status of an internal battery, and the signal strength for an internal cell phone application. The touch-screen display 30 also includes an icon 40 for accessing the “Inbox” of an email application, an icon 42 for accessing a contacts application, an icon 44 for accessing an appointment calendar application, an icon 46 for accessing an audio player application, an icon 48 for accessing an voice memo application, an icon 50 for accessing a modem, an application 52 for locking the system, and an icon 54 for turning off wireless functionality when flying in an airplane. The functions represented by each of these icons 40-54 can be selected by pressing the icon on the touch-screen display 30. The particular icon 40-54 that is selected is shown in the display 30 at 56.

The keypad 34 includes directional keys 60a-d that perform different functions depending on which application is being accessed. The directional keys 60a-d are used to move a cursor up, to the right, down, and to the left, respectively, when alphanumeric text is shown in the touch-screen display 30. When the audio player application is active, the directional keys 60a,c are used to increase or decrease the volume, respectively, and the directional keys 60b,d are used for respectively moving forwardly or a rearwardly in an audio selection. The directional keys 60a-d surround an Enter key 62 that is used in a conventional manner.

The keypad 34 also includes a menu key 66 that causes menu items to be shown in the touch-screen display 30, a home key 68 that causes the display 30 to show the icons 40-54 illustrated in FIG. 2, an “Esc” or cancel key 70 that is used to cancel a current selection, and an Enter key 72 that essentially performs the same function as the Enter key 62. The key 72 and key 70 can also be used as “call” and “end call” buttons, respectively, when the module LID 28 is used to implement telephone applications.

Also included with the keypad 34 are three audio control keys that are used when the audio playback application is active. These audio control keys are a key 80 for selecting a previous track, a play/pause key 82, and a next track key 84, which are used in a conventional manner.

In one embodiment, the computer system 10 also includes a side wheel 86 (shown in FIG. 1) mounted on the side of the computer system 10 that can be rotated in either direction by manipulating the wheel 86 with a thumb. The side wheel 86 allows a user to scroll through menu items shown on the touch-screen display 30 when either the menu key 66 or an application running on the computer system 10 displays a menu. The side wheel 86 can also be used for other functions that are supported by the LID module 28, such as a “zoom” control in certain applications to change the scale at which an item is shown on the display 30. Finally, the side wheel 86 may be used to configure the computer system 10, such to adjust the contrast of the main display 24 and the touch-screen display 30, to toggle the touch-screen display 30 on and off, to control the volume of internal speakers, etc. The side wheel 86 can also be pressed inwardly along the axis of rotation to generate a key click, which is generally used to perform an enter or select a function. As also shown in FIG. 2, the computer system also includes a video camera lens 88 that allows video frames to be saved as a video file, and may be used with a Webcam application. It will be understood, however, that user input devices other than the touch screen display 30, keypad 34, side wheel 86, etc. may be used.

The LID module 28 may be used to provide access to the applications corresponding to the icons 40-54 when the lid 12 is closed and the computer system 10 is turned off or when the lid 12 is closed and the computer system 10 is in a low power mode. As explained in greater detail below, the applications corresponding to the icons 40-54 are executed by a low power processor that consumes relatively little power. Therefore, the LID module 28 can be used to perform key tasks like checking emails, viewing contact and calendar information, and recording voice memos when the computer system 10 is in a low power mode. When the computer system 10 is turned on, a high power processor is used to provide all of the functionality of the computer system 10, and it consumes a substantial amount of power at that time.

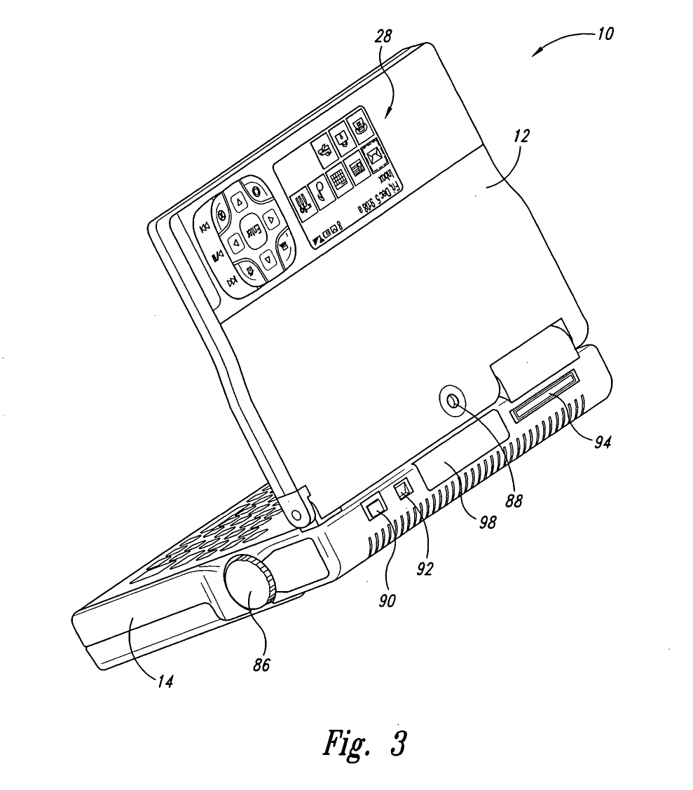

As shown in FIG. 3, the computer system 10 includes most of the usual connectors for connecting to external devices. More specifically, the computer system 10 includes a conventional mini-universal serial bus (“USB”) port 90, a DC power input jack 92, and a docking connector 94 including additional USB ports. The various communication ports can be used to provide communication between an external device and the computer system 10. Many such peripheral devices are well known, for example, printers, digital cameras, scanners, external disk drives, and the like. Although not shown in FIG. 3, the computer system also includes an Ethernet port, a modem port, a serial port, etc. The rear portion of the computer system 10 further includes an antenna 98 for wireless communication. The computer system 10 can be equipped with wireless capability using IEEE 802.11 WiFi, Bluetooth, or other wireless communication protocols. The antenna 98 can be utilized for transmission as well as reception of wireless signals. The computer system 10 also includes an internal battery (not shown in FIGS. 1-3) as well as in internal AC powered battery charger (not shown).

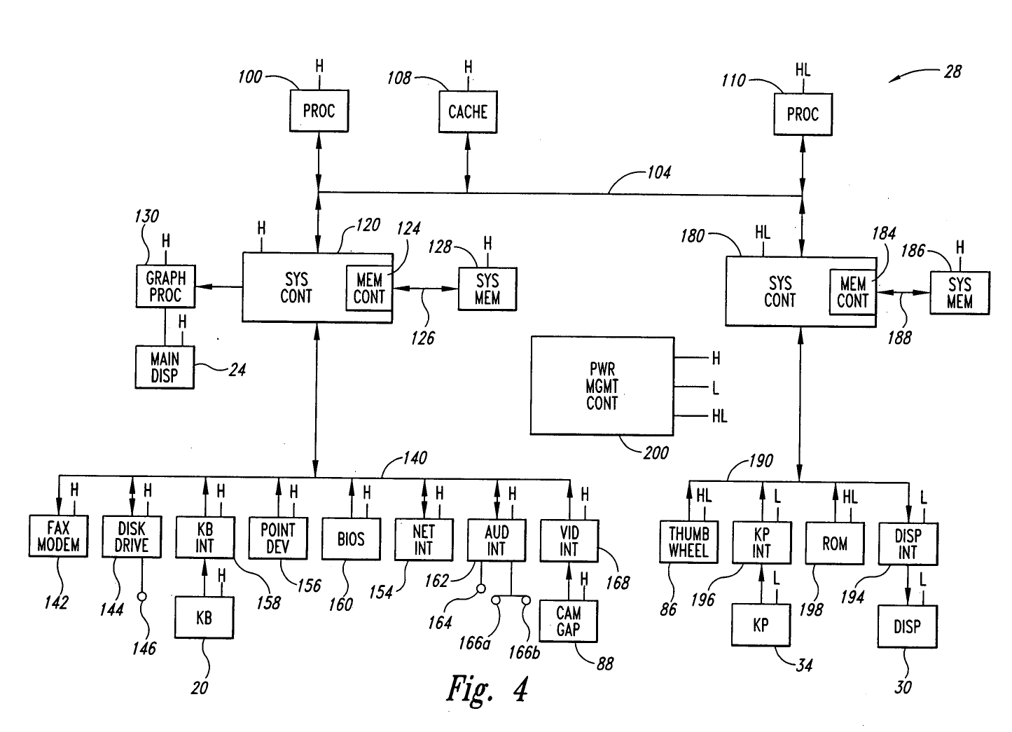

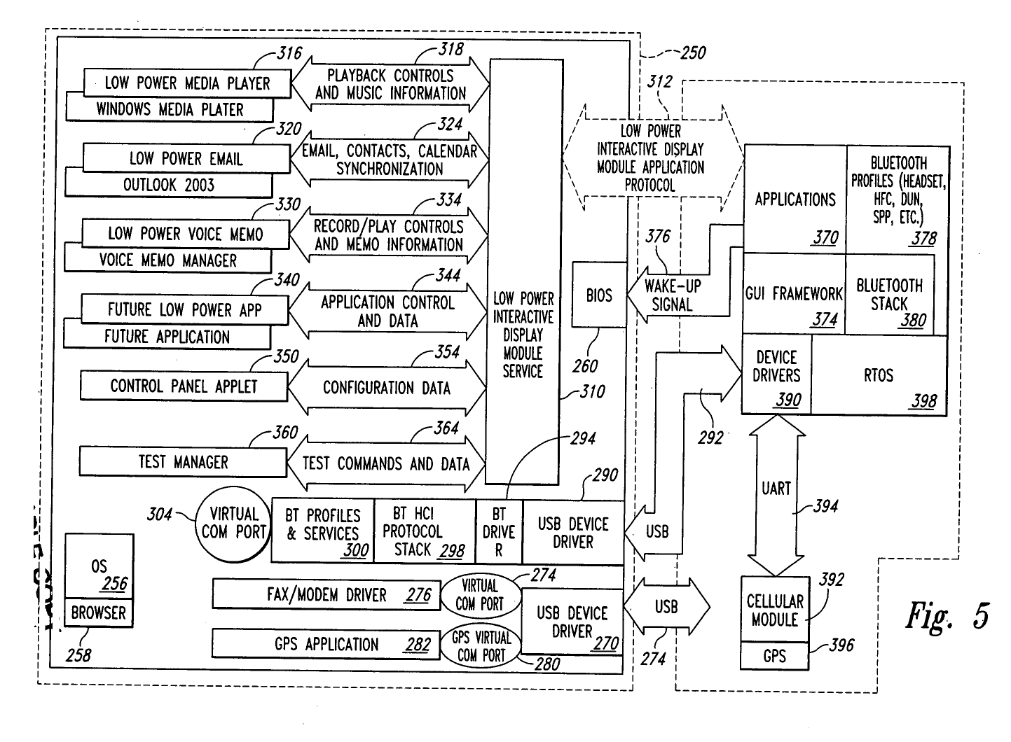

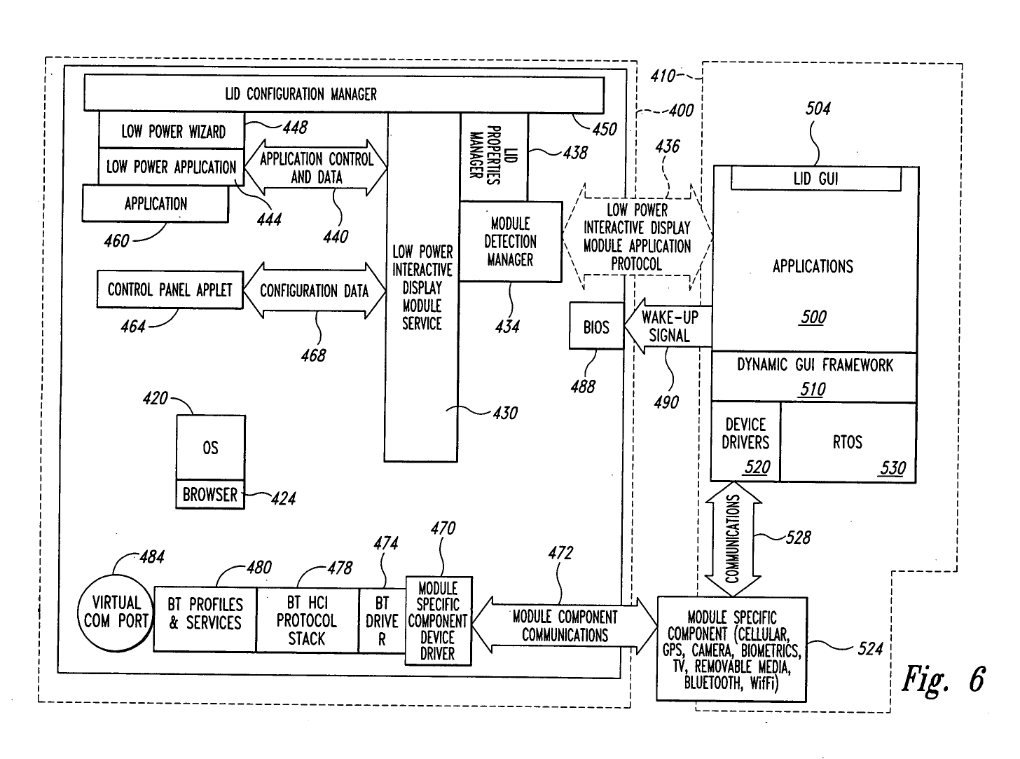

The hardware architecture of the computer system 10 will now be explained with reference to the block diagram of FIG. 4. The hardware of the computer system 10 provides a suitable computing environment for the software architecture, which will be described with reference to FIGS. 5 and 6. The computer system 10 includes a high power processor 100 coupled to a processor bus 104. The processor bus 104 preferably includes a command/status bus, an address bus and a data bus. Although the high power processor 100 preferably includes a level 1 (“L1”) cache, the computer system 10 includes a level 2 (“L2”) cache 108, which is coupled to the high power processor 100 through the processor bus 104. The L2 cache 108 includes the usual tag and data memories, which are normally implemented using static random access memory (“SRAM”) devices. A low power processor 110 is also coupled to the processor bus 104, although the low power processor 110 preferably does not access the L2 cache 108. The low power processor 110 is used to support the functionality that is available using the LID module 28.

The high power processor 100 accesses a number of computer components through a system controller 120, which is also connected to the processor bus 104. The system controller 120 includes a memory controller 124 that is coupled through a memory bus 126 to a system memory 128. The memory bus 126 includes a command bus through which memory commands are passed to the system memory 128, an address bus specifying a location in memory that is being accessed by a read or write command, and a bi-directional data bus through which write data are passed to the system memory 128 and read data are passed from the system memory 128. A suitable random access memory device, typically a dynamic random access memory (“DRAM”) device, is used as the system memory 128.

The system controller 120 also includes a graphics port that is coupled to a graphics processor 130. The graphics processor 130 is, in turn, coupled to the main display 24, which may be a liquid crystal display (“LCD”), but may also be an organic light emitting diode (“OLED”) display, a plasma display, a field emission display (“FED”), or some other type of display.

The system controller 120 also serves as a bus bridge between the processor bus 104 and a peripheral bus 140, which may be a peripheral component interconnect (“PCI”) bus. The peripheral bus 140 is coupled to a FAX/modem 142 and a disk drive 144 accessing a hard disk 146, which together provide non-volatile storage of computer readable instructions, program modules, data structures, and other data. However, other types of non-volatile storage may also be used, such as flash memory cards, recordable CD-ROM and DVD disks, Bernoulli cartridges, smart cards, to name a few. The peripheral bus 140 is also coupled to a network interface 154 that is used to provide communications through a suitable local area network (“LAN”), such as an Ethernet network. The network interface 154 may also provide access to a wireless network, such as 802.11 WiFi, Bluetooth, cellular using TDMA, FDMA and/or CDMA protocols, or some other wireless communication link. As part of the user interface for the computer system 10, the peripheral bus 140 is also coupled to a pointing device 156, such as an external mouse and the touchpad 22, and a keyboard interface 158, which is coupled to the keyboard 20. The peripheral bus 140 is coupled to a read only memory (“ROM”) device 160, which stores a basic input/output system (“BIOS”) program that includes a boot sequence, which is executed by the high power processor 100 at power-up. The BIOS program stored in the ROM device 160 will be described in greater detail with reference to FIG. 5. The BIOS program is preferably shadowed by being transferred from the ROM device 160 to the system memory 128 as part of the boot sequence, and it is then executed by the high power processor 100 from the system memory 128.

The peripheral bus 140 is also coupled to an audio interface 162 that is connected to an internal microphone 164 and a pair of speakers 166a,b. The audio interface 162 includes a digital-to-analog converter having a pair of outputs that are coupled to the speakers 166a,b. The audio interface 162 also includes a sampler producing analog samples of a signal from the microphone 164, and an analog-to-digital converter, which digitizes the analog samples and passes the digital sample data to the peripheral bus 140. Finally, a video interface 168 is coupled to the peripheral bus 140 for receiving an analog video signal from the camera 88 (FIG. 2). The video interface 168 includes a sampler producing analog samples of a video signal from the camera 88, and an analog-to-digital converter, which digitizes the video samples and passes the digital video data to the peripheral bus 140.

As mentioned above, the computer system 10 also includes the low power processor 110. The low power processor 110 is coupled through the processor bus 104 to an auxiliary system controller 180, which also includes a memory controller 184. The memory controller 184 is coupled to a system memory 186, which may be a DRAM device, through a memory bus 188. The system memory 186 has a capacity that is smaller than the capacity of the system memory 128, and it may operate at a substantially slower speed. The system memory 186 may be accessed by either the high power processor 100 or the low power processor 110.

The system controller 184 is coupled to a peripheral bus 190, which may be a PCI bus, and ISA bus or some other type of bus. The system controller 184 and the peripheral bus couple the low power processor 110 to the side wheel 86, a display interface 194 for the touch-screen display 30, and a keypad interface 196, which is coupled to the membrane keypad 34. The peripheral bus 190 is also coupled to a ROM 198 that stores a BIOS program and operating system for the low power processor 110. The ROM 198 also stores the firmware for the applications used by the LID module 28. These applications are run on the low power processor 110, which, in conjunction with the system controller 180, system memory 186 and components coupled to the peripheral bus 190, are used to support the functionality of the LID module 28.

The final component of the computer system 10 shown in FIG. 4 is a power management controller 200. A variety of conventional power conserving suspend states and sleep modes are supported by the BIOS program stored in the ROM 160, including S4 hibernation, S3 standby, S3 standby with the low power processor 110, the touch-screen display 30, and the keypad interface 196 powered, and S2 with only the components needed for audio playback powered. In some of these modes, the contents of the system memory 128 are transferred to the hard disk 146, and power is then removed from the system memory 128.

Unlike conventional computer systems, the power management controller 200 used in the computer system 10 of FIG. 4 includes a high power supply output “H,” which is powered in a high power mode, a low power supply output “L,” which is powered in a low power mode, and a high/low power supply output “HL,” which is powered in both modes. As shown in FIG. 4, the high power processor 100, the cache 108, the system controller 120, and all of the components that are directly or indirectly coupled to the system controller 120 are powered in the high power mode. In the low power mode, only the components needed to support the LID module 28, i.e., the low power processor 110, the system controller 184, and the components directly or indirectly coupled to the system controller 184, are powered. However, in the high power mode, all of the components that are powered in the low power mode also receive power except for the touch-screen display 30 and the keypad interface 196. Thus, in the high power mode, the low power processor 110 can continue to execute code from the system memory 186 in the LID module 28 even though the touch-screen display 30 is off and inputs from the keypad 34 are ignored. However, the LID module 28 will continue to synchronize email, contacts, calendar and other information needed to keep the data in the LID module 28 coherent with the data in the other portion of the computer system 10.

Although the high power processor 100 is shown as being coupled to the low power processor 110 through a common processor bus 104, it will be understood that they may be coupled to each other by other means. For example, the high power processor 100 and the low power processor 110 may be coupled to respective processor buses (not shown) that are isolated from each other, and the processors may be coupled to each other through communications links (not shown).

In operation, the computer system 10 boots up in the high power mode at power-up using the high power processor 100 after the boot sequence and the operating system have been transferred to the system memory 128. The low power processor 110 boots up by executing a BIOS program stored in the ROM 198 after it has been shadowed to the system memory 186. The operating system for the low power processor 110 is also transferred from the ROM 198 to the system memory 186. However, the BIOS program and the operating system for the low power processor 110 may be transferred to the system memory 186 by other means. For example, the BIOS program and operating system may be stored in the hard disk 146 and transferred to the system memory 186 by the high power processor 100. Once the operating systems have been loaded into the system memories 128, 186, the computer system 10, including the LID module 28, are operational. However, the touch-screen display 30 and keyboard interface 158 are not operational. Therefore, the user interface is provided primarily by the keyboard 22, the touchpad 22, and the main display 24.

When the computer system 10 switches to the low power mode, the power management controller 200 removes power from the high power supply output H, and applies power to the touch-screen display 30 and keyboard interface 158 by applying power to the HL output of the power management controller 200. Thereafter, only the LID module 28 components are powered, and the only operable user interface for the computer system 10 are the touch-screen display 30, the keypad 34, and the side wheel 86. However, the low power processor 110 does have the ability to “wake-up” or re-power the high performance processor 100 to access components in the computer system 10. Although the relatively low performance of the processor 110 and the relatively small capacity and slow speed of the system memory 186 do not provide nearly the processing capabilities of the high power processor 100 and system memory 128, they provide adequate processing capability to perform the functions accessed through the LID module 28. As explained above, these functions include email, access to a contacts listing, access to an appointment calendar, and playing audio tracks. Moreover, these functions can be easily accessed since it is not necessary to open the lid 12 (FIGS. 1-3) or wait for a boot sequence to run and operating system to be loaded.

When returning to the high power mode, the high power processor 100 executes the BIOS program stored in the ROM device 160 in the same manner as at power-up. The power management controller 200 then removes power from the touch screen display 30 and keyboard interface 20 by removing power from the L output of the power management controller 200. Thereafter, the user interface for the computer system 10 includes the main display 24 and the keyboard 20, although the LID module 28 is still operational in the high power mode except for the touch-screen display 30 and the keypad 34.

The software architecture of the computer system 10 is shown in FIG. 5. The software for the computer system 10 is essentially divided between computer system software 250 executed by the high power processor 100 (FIG. 4), and LID module software 254 executed by the low power processor 110, which is used to support the LID module 28. The software 250 includes an operating system 256, such as Microsoft® Windows XP®, which provides a suitable computer environment for the other software 250. The operating system 256 also includes a web browser 258 that may be markup language-based, such as Hypertext Markup Language (“HTML”), Extensible Markup Language (“XML”) or Wireless Markup Language (“WML”). A suitable browser 258 that may be used is the Microsoft® Internet Explorer®.

A BIOS program 260 is transferred from the ROM device 160 and the operating system 256 is transferred from the disk drive 144 to system memory 128 at power-up. The BIOS program 260 is then executed by the high power processor 100 from the system memory 128. The BIOS program 260 allows for multiple boot sources, including the disk drive 144, a USB floppy connected to the USB port, a USB CD-ROM/DVD, and a USB Ethernet port. The BIOS program 260 also provides a crisis recovery for the BIOS and the operating system, and it includes a conventional BIOS Flash Utility.

The computer system software 250 also includes a universal serial bus (“USB”) device driver 270 that is used to establish serial communications through a USB bus 274 with the LID module software 254 executed by the low power processor 110. The USB device driver 270 interfaces with a virtual communications port 274 that provides communications with a driver 276 for the Fax/Modem 142 (FIG. 4). The cellular module 392, in combination with the USB device driver 270, virtual communications port 274 and Fax/Modem 276 allow a cellular phone to be used as a cellular modem. The USB device driver 270 also interfaces with a global positioning system (“GPS”) virtual communications port 280 that allows one or more GPS applications 282 to receive real time position information.

The computer system software 250 executed by the high power processor 100 also includes a second USB device driver 290 that is also used to establish serial communications through a USB bus 292 with the software 254 executed by the low power processor 110. The USB device driver 290 interfaces with a Bluetooth driver 294, which, in turn, interfaces with a Bluetooth CHI Protocol Stack 298 and a Bluetooth Profiles & Services List 300. These Bluetooth components are accessed by the operating system 256 through a virtual communications port 304 for use by various applications, such as mapping programs, that require position information.

As previously explained, the low power processor 110 provides access to certain applications in the low power mode using the LID module 28. The low power processor 110 can access these applications and other software running on the LID module 28 through a Low Power Interactive Display Module Service (the “Module Service”) 310 and a Low. Power Interactive Display Module Application Protocol (the “Protocol”) 312. The Module Service 310 interacts with software components running under the operating system 256 to provide access to a Low Power Media Player application 316, such as Windows® Media Player, through playback controls and music information 318. The Module Service 310 also provides access to a Low Power Email and other applications 320, such as Outlook 2003, through email, contacts and calendar synchronization 324. The email application may receive emails though a wireless link accessed through the network interface 154 (FIG. 4), and it may periodically download emails, such as every 10 minutes, and cache them for viewing by a user. As a result, email messages can be made instantly available. The email application may allow the user to select in advance which attachments to emails will be downloaded with periodically downloaded messages. These attachments are then downloaded in background so the email application is not tied up. In the high power mode, email capability is provided by an email application running on the operating system 256 of the computer system 10.

The Protocol 312 allows the functions available on the LID module 28 to also be available in the computer system 10. To accomplish this, the Protocol 312 uses platform-independent data types to allow data types to be defined appropriately for each platform. The Protocol 312 also provides interfaces for suitable programming languages, such as C and C++. The core of the Protocol 312 is a set of messages or data packets that are passed between the Module Service 310 and the applications being run in the LID module 28. The Protocol 312 uses messages that are tailored to the needs of each application, i.e. the email, contacts, calendar and audio player applications. The general format of each message in the Protocol 312 is a Type field, a Length field, and a Data field. The Type field indicates the kind of message, the length field specifies the number of bytes of data in the message, and the Data field is variable length block of data providing information having a format implied by the kind of message designated by the Type field. Message types and the format of their corresponding data may be defined in a header file containing structures that can be used by both C code for the software executed by the low power processor 110 and C++ for the software executed by the high power processor 100 through the Module Service 310. Thus, a Type field for an email message will imply a format for the Data field that is different from the format of the Data field implied by a Type field for a calendar message. However, other message formats for the Protocol 312 may be used. For example, a Sequence number, cyclic redundancy check (“CRC”) value and Priority Level may be added. The use of a Sequence number allows a receiver of a message to determine if a message has been lost. The CRC field allows errors in the Data field to be detected, and the Priority Level field allows the receiver to prioritize sequentially received messages.

A Low Power Voice Memo application 330, such a Voice Memo Manager, is also accessible through the Module Service 310, which extracts the Protocol 312 from record/play controls and memo information 334. Expandability is built into the computer system 10 to support a Future Low Power application 340 through application control and data 344. As explained below, the application control and data 344, and the Protocol 312 from which they are generated by the Module Service 340, may be specific to an application or they may be generic to whatever application is needed to support a feature of the LID module 28.

The LID module software 254 being executed by the low power processor 110 is configured using a Control Panel Applet 350 through configuration data 354, which is provided to the LID module software 254 through the Module Service 310. Finally, a Test Manager 360 provides the LID module software 254 with test commands and data 364 that allows the low power processor 110 to execute various self-test routines.

The LID module software 254 includes various applications 370 that are executed by the low power processor 110, and a graphics user interface framework 374 that configures the touch-screen display 30 to provide an interface with a user, keypad 34 and side wheel 86. The LID module software 254 provides a wake up signal 376 when one of the applications 370 or other LID module software 254 requires access to the computer system software 250. The wake-up signal is coupled to an interrupt port of the high power processor 100, which, after be interrupted by the wake-up signal, causes power to be applied to the components that are powered by the high power supply voltage H from the Power Management Controller 200 (FIG. 4) so that the LID module software 254 can access the computer system software 250.

Also included are Bluetooth profiles 378 that interface with a Bluetooth stack 380 to provide Bluetooth wireless capability using a Bluetooth capable cell phone. The LID module software 254 includes device drivers 390 that are coupled to the USB bus 292 and to a Cellular Module 392 through a universal asynchronous receiver/transmitter (“UART”) 394, which provides access to cellular service, and a GPS module 396 that provides real time position data.

The platform on which the above-described LID module software 254 runs is a suitable real time operating system (“RTOS”) 398. As explained above, the operating system 398 is executed by the low power processor 110 from the system memory 186 to provide the functionality of the LID module 28. The RTOS 398 and the Application 370 cause the low power processor 110 to act as a master to the high power processor 100 in the low power mode. In the high power mode, the RTOS 398 and the Application 370 cause the high power processor 100 to act as a master to the low power processor 110.

Another embodiment of computer system software 400 is shown in FIG. 6. The software 400 has the advantage of providing generic support to another embodiment of LID module software 410 so that the software 400 need not be specific to functions performed by the LID module 28. Instead, the software 400 can generically support the LID module software 410 as new functionality is incorporated in the LID module 28. As a result, the LID module 28 can automatically configure an application added to the computer system 10 for execution by the high power processor 100. The software 400 thus provides the LID module 28 with “plug and play” capability of new applications.

With reference to FIG. 6, the computer system software 400 includes an operating system 420, such as Microsoft® Windows XP®, which, as previously mentioned, includes a web browser 424, such a Microsoft® Internet Explorer®. The computer system software 400 also includes a Low Power Interactive Display Module Service (“Module Service”) 430 that interfaces with the LID module software 410 through a Module Detection Manager 434 using a low power interactive display module application protocol (“Application Protocol”) 436. The Application Protocol 436 messages are not tied to specific applications. Instead the Application Protocol 436 messages provide sufficient information about the LID module software 410 based on information from the Module Detection Manager 434 that the Module Service 430 can configure the applications included in the computer system software 400. Similarly, a Lid Properties Manager 438 provides information about the properties of specific components in the LID module 28 that allow the Module Service 430 to also configure various applications included in the computer system software 400. More specifically, the Module Service 340 uses the information to provide application control and data 440, which is passed to a Low Power Application 444. The application control and data 440 is used to configure the Low Power Application 444 so that it can suitably operate with specific hardware and software in the LID module 28, such as cellular phones with or without GPS, camera or Bluetooth capabilities. The Low Power Application 444 is configured by a Low Power Wizard 448 using the application control and data 350 under control of a Lid Configuration Manager 450.

The computer system software 400 also includes various applications 460 that use the platform of the operating system 420 when the computer system 10 is operating in the high power mode. As with the computer system software 250 of FIG. 5, the computer system software 400 also includes a Control Panel Applet 464 to which configuration data 468 is passed.

The computer system software 400 also includes a Module Specific Component Device Driver 470 that provides communications with specific components in the LID module 28 using Module Component Communications 472. The Module Specific Component Device Driver 470 interfaces with a Bluetooth driver 474, which, in turn, interfaces with a Bluetooth HCI Protocol Stack 478 and a Bluetooth Profiles & Services List 480. These Bluetooth components are accessed by the operating system 420 through a virtual communications port 484.

Finally, a Kernel 488 is provided in the computer system software 400 to allow the LID module software 410 to switch the computer system 10 to the high power mode responsive to a wake-up signal 490.

The LID module software 410 includes various applications 500 that are executed by the low power processor 110, and a graphics user interface 504 that provides an interface with a user through the touch-screen display 30, keypad 34 and side wheel 86. The LID module software 410 provides the wake-up signal 490 when one of the applications 500 or other LID module software 410 requires access to the computer system software 400. As mentioned above, the wake-up signal causes power to be applied to the components that are powered by the high power supply voltage H from the Power Management Controller 200 (FIG. 4) so that the LID module software 410 can access the computer system software 400.

Also included in the LID module software 410 is a Dynamic GUI Framework 510 that configures the interface provided by the touch-screen display 30, keypad 34 and side wheel 86 to specific components that may be used in the LID module 28. Device drivers 520 are used to access various Module Specific Components 524 through a communications link 528. These Module Specific Components 524 may be a cellular telephone, a GPS receiver, a camera, a biometric identification device, a television receiver, removable media, and various wireless protocols such as WiFi and Bluetooth, to name a few. Finally, a suitable real time operating system (“RTOS”) 530 is executed by the low power processor 110 from the system memory 186 to provide the functionality of the LID module 28.

Although the present invention has been described with reference to the disclosed embodiments, persons skilled in the art will recognize that changes may be made in form and detail without departing from the spirit and scope of the invention. Such modifications are well within the skill of those ordinarily skilled in the art. Accordingly, the invention is not limited except as by the appended claims.

1-64. (canceled)

65. A method of operating a computer system having a first processor operatively coupled to a main display and a second processor operatively coupled to an auxiliary display, the first processor having substantially higher performance and substantially higher power consumption than the second processor, the method comprising:
in a high power mode, applying power to the first processor so that the first processor can function with the main display in the high power mode; and
in a low power operating mode, removing power to the first processor and applying power to the second processor so that the second processor can function with the auxiliary display in the low power operating mode.

66. The method of claim 65, further comprising applying power to the second processor in the high power mode so that the second processor and auxiliary display are functional in the high power mode.

67. The method of claim 65, further comprising passing an application protocol message between the first processor and the second processor in connection with the running of a first application using the first processor.

68. The method of claim 67 wherein the application protocol message comprises a type field identifying an application pertaining to the application protocol message, the application protocol message further comprising a data field having a format corresponding to the application identified by the type field.

69. The method of claim 67 wherein the application protocol message is operable to configure the first application to provide plug and play compatibility for features provided by the first application.

70. The method of claim 67 wherein the application protocol message is passed from the second processor to the first processor.

71. The method of claim 70 wherein the computer system further comprises a module service to which the application protocol message is passed, and wherein the method further comprises using the module service to extract control information from the application protocol to control the running of a first application using the first processor.

72. The method of claim 67 wherein the application protocol message is passed from the second processor to the first processor.

73. The method of claim 72 wherein the computer system further comprises a module service to which the application protocol message is passed, and wherein the method further comprises using the module service to generate the application protocol from data passed to the module service by the first application.

74-88. (canceled)
